(19) United States
(12) Patent Application Publication
(10) Pub. No.: US 2025/0351800 A1
(43) Pub. Date: Nov. 20, 2025

(54) CATTLE CRUSH AUTOMATION SYSTEM

(71) Applicant: Moaci Ribeiro Madeira CAMPOS NETO, Bezerros/ Pernambuco (BR)

(72) Inventor: Moaci Ribeiro Madeira CAMPOS NETO, Bezerros/ Pernambuco (BR)

(21) Appl. No.: 19/204,348

(22) Filed: May 9, 2025

(30) Foreign Application Priority Data
May 14, 2024 (BR) 10 2024 009509 0

(51) Int. Cl. A01K 1/06

(52) U.S. Cl. CPC A01K 1/0613

(57) ABSTRACT

A cattle crush automation system having a metal cattle crush fitted with at least one chain drive system or at least one worm drive system driven locally or remotely by electric motors, and a method of automatically handling cattle in a cattle crush.

### FIELD OF APPLICATION

The subject of this patent application applies to the automated driving of cattle crushes.

### STATE OF THE ART

Vaquejada is a sporting activity that involves two cowboys riding horses on a sandy track. They chase an ox, grab its tail and bring it down in a track at a specific distance from the cattle crush.

The cattle crush is a wooden structure with vertical stakes and horizontal boards that form a corridor connecting the corral to the track for the passage of the oxen.

The corral has different shapes, but the part that leads to the cattle crush is conical, forcing the animals to line up. To prevent the oxen from backing up or running off together, there are cross beams.

Handling the oxen out of the cattle crush is not easy, often requiring shocks, pokes and tail pulls, which stresses and mistreats them, as well as wearing out the cowboys who work in the corral handling the oxen in the cattle crush.

Such conduct could be interpreted as mistreatment of animals and this has been the subject of protests by animal protection groups.

Despite this, vaquejada is important economically and is part of Brazilian culture, especially in the Northeast.

Document BR. 102014001201-0 describes a piece of equipment for driving ox out of a vaquejada cattle crush, which drives the ox onto the vaquejada race track by means of a piece of equipment consisting of a kind of cage, a door lifting portal, a drag door, a door pulling device, pulling motors, horizontal rails, vertical rails and an optional motorized conveyor belt.

However, this equipment only works in the final stretch of the cattle crush, pushing only the last ox in the cattle crush that is about to enter the vaquejada arena. In other words, if the oxen in the cattle crush before this equipment stop, the cowboys will have to use traditional techniques to get the last ox into the final part of the cattle crush where the equipment described in this document is installed. In addition, as vaquejada has a short time between the oxen leaving the cattle crush and entering the vaquejada arena, this equipment doesn't meet the demands of vaquejada.

Document BR102020020247-2 describes an automated animal handling cattle crush system consisting of an electric hoist, a support structure for the hoist made up of beams of 02 “U” profiles of 3 inches and 01 “U” profile of 4 inches or similar, two rails of variable length made of 02 angle brackets of 1 and M inches by 3/16 inches or similar and a sheet of thickness of 3 mm by 1. 20 m ( 3/16″) or similar welded together with two hooks for eyebolts, 20 m ( 3/16″) or similar welded, two sets of 04 3-inch pulleys or similar fixed to a 3 mm by 1.20 m ( 3/16″) sheet or similar with two eye hooks and a hook for fixing made from ⅜″ smooth rod or similar, a steel chain and a leather strap or similar. A lengthening device (12) is made using a 3-inch “U” profile or similar, which supports the ox to be pulled. Like the previous document, this equipment only works on the final stretch of the cattle crush, pushing only the last ox in the cattle crush that is about to enter the vaquejada arena.

In other words, if the oxen in the cattle crush before this equipment stop, the cowboys will have to use traditional techniques to get the last ox into the final part of the cattle crush where the equipment described in this document is installed. In addition, as vaquejada has a short time between the oxen leaving the cattle crush and entering the vaquejada arena, this equipment doesn't meet the demands of vaquejada.

With the aim of improving the vaquejada event, avoiding mistreatment of the animals and speeding up the exit of the oxen from the cattle crush over the entire length of the cattle crush, the present invention was developed.

### SUMMARY OF THE INVENTION

The object of the present invention is:
To provide an assemblable, disassemblable and transportable metal cattle crush that can be installed in any corral or place where cattle need to be handled through a cattle crush;
Provide a cattle crush with an automatic cattle handling system to force cattle through the cattle crush without mistreating them;
Eliminate the cowboys' effort in handling the oxen along the cattle crush, and especially at the exit of the cattle crush to move oxen that stall and only come out of the cattle crush by means of a lever with wooden handles or shocks;
Providing a system and method of handling cattle that prevents them from stalling at the entrance, middle and exit of the cattle crush; and
Providing a safe automated cattle crush that meets the demand for releasing cattle into the vaquejada arena according to the demand of the vaquejada, preventing delays in the oxen leaving the cattle crush.

The cattle crush automation system of the present invention is made up of a metal cattle crush with vertical tubes connected by connecting means to the horizontal tubes forming the sides of the cattle crush and transverse tubes that connect the two sides of the cattle crush by connecting means giving structure and preventing the sides of the cattle crush from deforming laterally under the force of the oxen.

The cattle crush is divided into two parts, the entrance to the cattle crush where the oxen enter through the entrance door and move around until they reach the exit of the cattle crush. Between the entrance and exit of the cattle crush there is an intermediate drag gate that divides the entrance and exit of the cattle crush and at the exit of the cattle crush there is an exit drag gate through which the ox leaves the cattle crush and accesses the vaquejada arena. These doors move on rails with a caster system. These doors can be operated manually or automated with an electric motor and a local or remote control system.

The entrance to the cattle crush is a section long enough for at least one bovine animal and can be extended to fit as many oxen as desired.

A chain drive system or a worm drive system is installed on one side of the cattle crush entrance.

The chain drive system is driven by an electric motor fitted with a control that works in a circular and continuous manner so as to push all the oxen inside the entrance to the cattle crush simultaneously, preventing any of the oxen in the entrance to the cattle crush from getting stuck midway. This chain system runs along the entire length of the cattle crush entrance.

The drive control of the chain drive system can be local using a control with forward and reverse buttons, or it can be remote-controlled using wireless networks, cell phones or any technology that allows the electric motor of the drive system to be operated remotely.

The worm drive system is also driven by an electric motor and can be operated locally using a control with forward and reverse buttons, or remotely via wireless networks, cell phones or any technology that allows the electric motor of the drive system to be operated remotely. When the first ox enters the cattle crush, the carriage or worm bar support where the bar that pushes the cattle is placed must be in the starting position next to the cattle crush entrance door. When the bovine enters until its hind legs pass through the door, the bar is placed on the support behind the bovine's hind legs and, when the motor is started by turning the worm screw clockwise, the bar moves towards the exit of the cattle crush, pushing the bovine forward until it reaches the intermediate drag door. At this point, the intermediate drag door is opened and the bovine is pushed by the bar until it enters the final section of the cattle crush, the intermediate door is closed, and the motor is started to turn the worm counterclockwise, moving the carriage or support of the worm bar to its initial position in order to move another bovine from the entrance to the cattle crush.

At the exit of the cattle crush, between the first and second drag doors, a worm drive system, such as a vehicle elevator arm, is installed on one side of the cattle crush, either on the same side as the chain drive system or on the opposite side. The exit from the cattle crush is the section where only the ox that is going to leave through the second gate to enter the vaquejada arena stays, this traction system is stronger and more stable than the chain traction system because this is the section where the oxen create the most resistance to moving forward, as they don't want to enter the vaquero arena because they can see the two cowboys on their horses at the exit of the cattle crush and the spectators in the stands. 0 drive control of the worm drive system can be local using a control with forward and reverse buttons, or it can be remote-controlled using wireless networks, cell phones, or any technology that allows the electric motor of the drive system to be driven remotely.

The worm drive system is activated in order to push the ox out of the cattle crush exit as soon as the exit drag door is opened.

Both the chain drive system and the worm drive system can be coupled and uncoupled for mounting and dismounting the cattle crush and transporting it. The cattle crush of the present invention can have only one traction system, a chain traction system or an endless screw traction system; it can have two equal systems, two chain traction systems or two endless screw traction systems; or one system of each, either of which can be at the entrance or exit of the cattle crush.

As the entire structure of the cattle crush is made up of metal tubes that are connected by means of fittings, the cattle crush is easily assembled and disassembled so that it can be used in various vaquero arenas, or anywhere you want to organize the cattle in a line inside a cattle crush. The structure of the cattle crush can also have its elements connected by welding, leaving the structure fixed.

This system can be used in vaquejadas, riding tournaments, slaughterhouses, farms for vaccines, castrations, semen collection, fertilization, etc.

### BRIEF DESCRIPTION OF THE DESIGNS

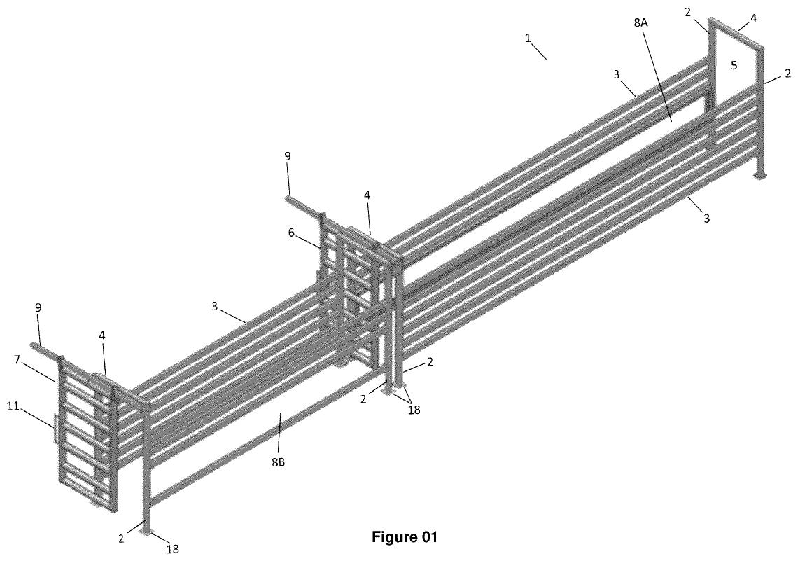

FIG. 01. This is a perspective view of the metal cattle crush without the traction systems.

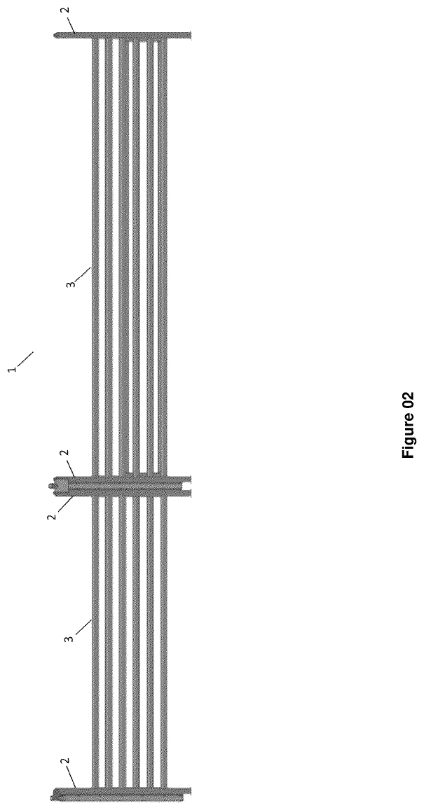

FIG. 02. It illustrates a right side view of the cattle crush without the traction systems.

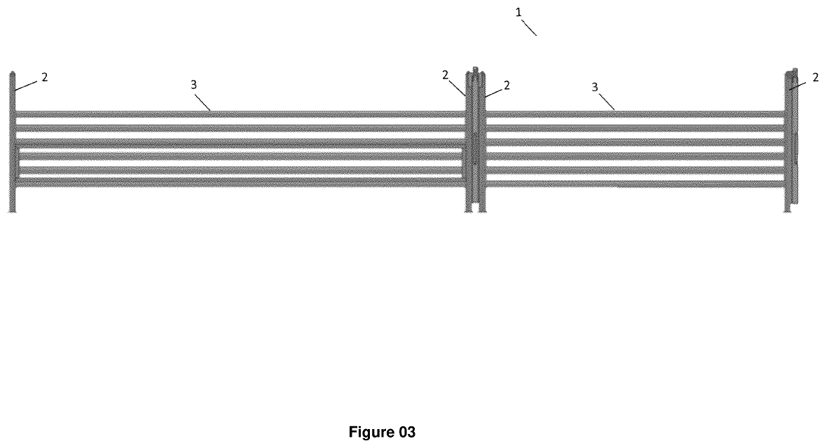

FIG. 03. This is a left side view of the cattle crush without the traction systems.

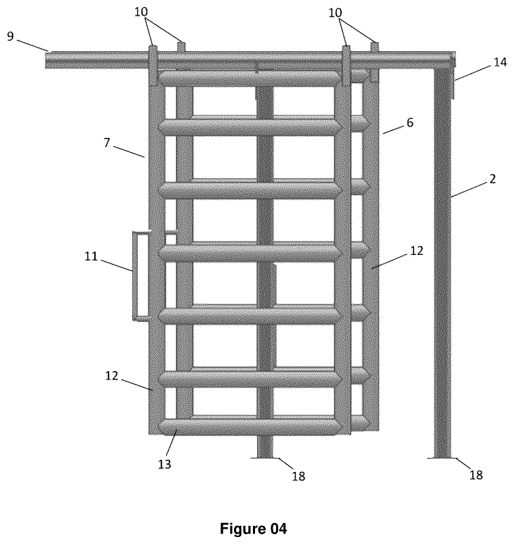

FIG. 04. This is a front view of the cattle crush without the traction systems.

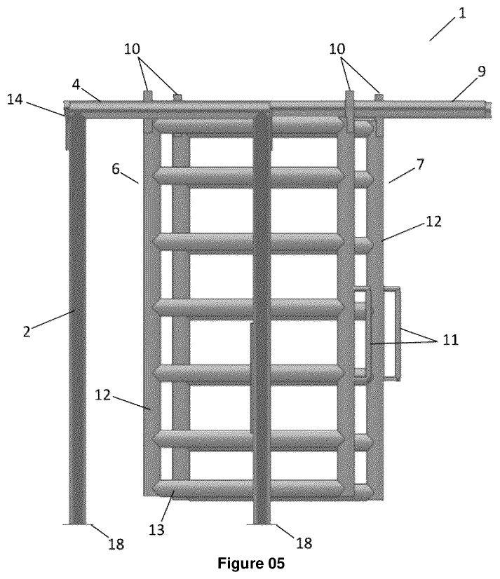

FIG. 05. This is a rear view of the barn without the traction systems.

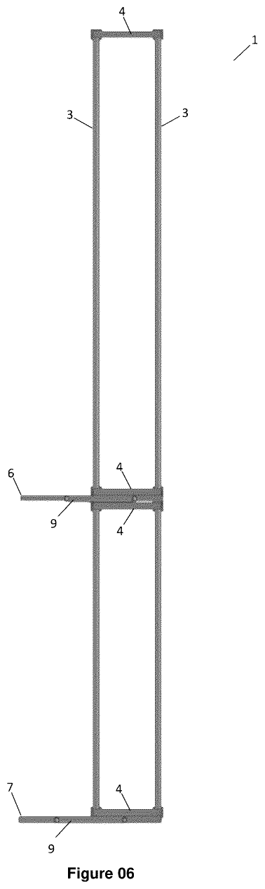

FIG. 06. This is a top view of the cattle crush without the traction systems.

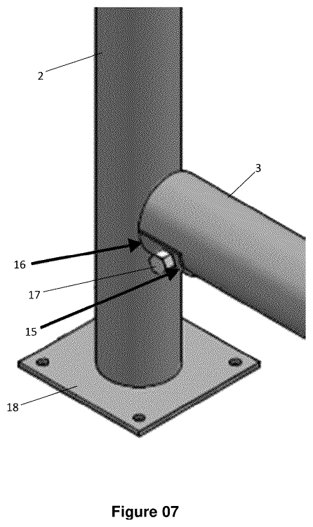

FIG. 07. It illustrates in detail an example of an embodiment of a means of connection between the vertical, horizontal and transverse tubes of the cattle crush.

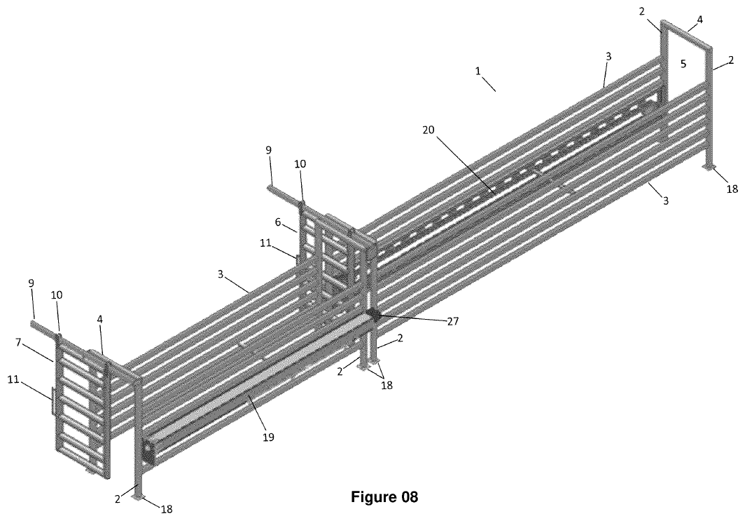

FIG. 08. This is a perspective view of the metal cattle crush with the traction systems.

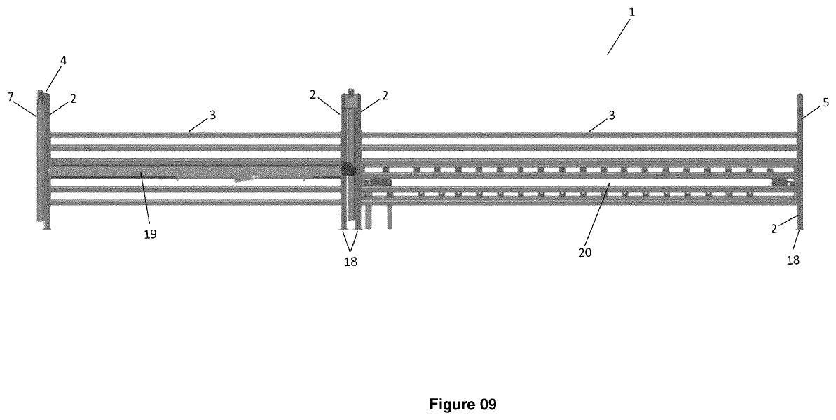

FIG. 09. It illustrates a right side view of the cattle crush with the traction systems.

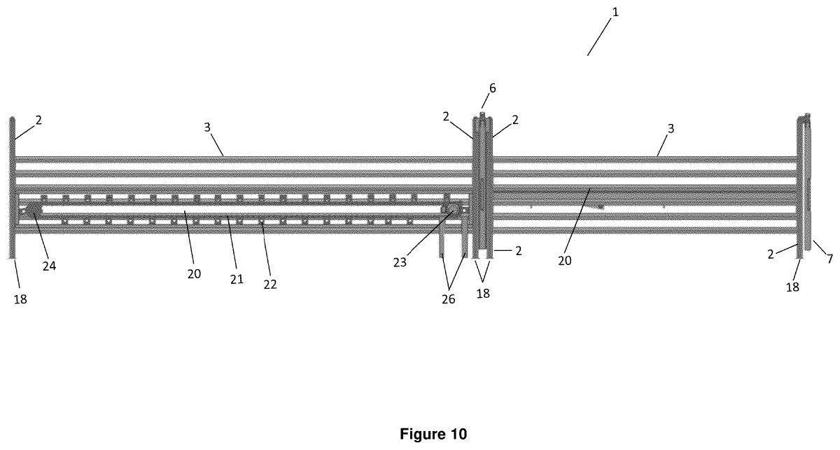

FIG. 10. It illustrates a left side view of the cattle crush with the traction systems.

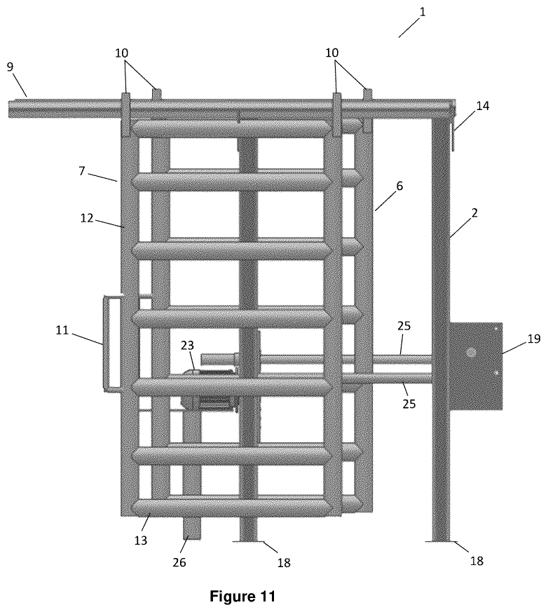

FIG. 11. It illustrates a front view of the cattle crush with the traction systems.

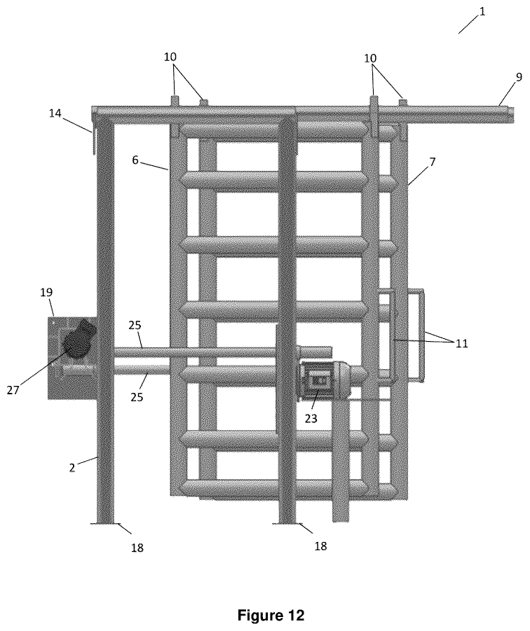

FIG. 12. It illustrates a rear view of the cattle crush with the traction systems.

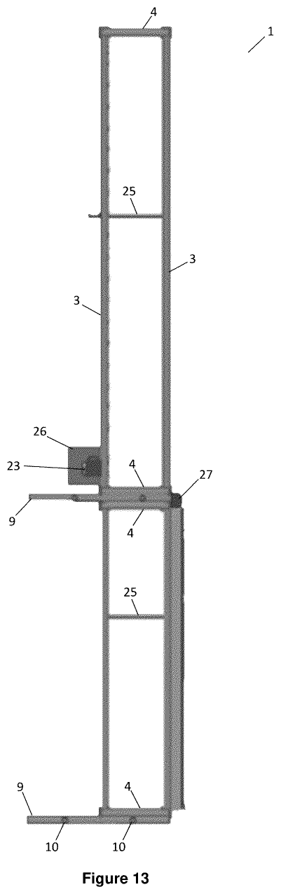

FIG. 13. It illustrates a top view of the cattle crush with the traction systems.

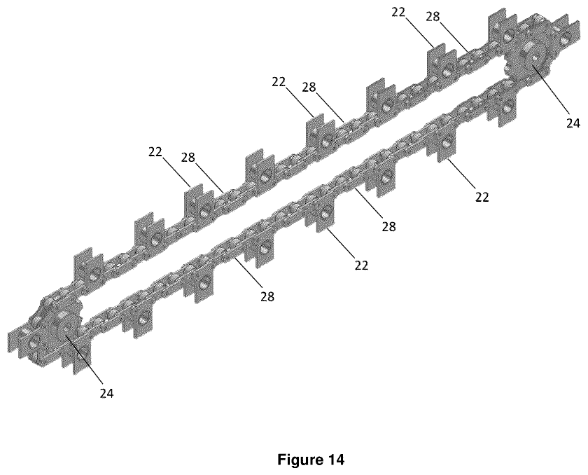

FIG. 14. It illustrates a view of the chain of the chain drive system.

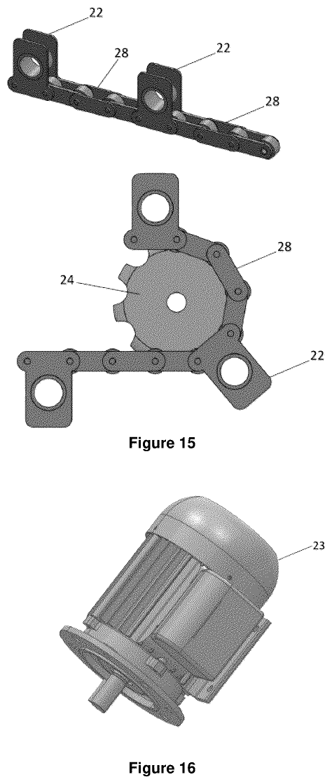

FIG. 15. This is a detailed illustration of part of the drive chain and the interaction between the chain and the gear.

FIG. 16. It illustrates perspective views of the electric motor of the chain drive system and the worm drive system.

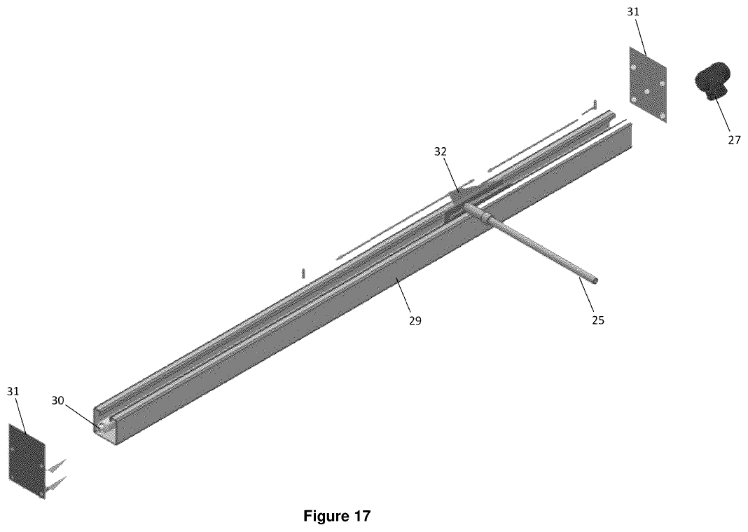

FIG. 17. Exploded view of the worm drive system.

### DETAILED DESCRIPTION OF THE INVENTION

The invention will now be described in detail on the basis of the figures.

As shown in FIGS. 01, 02 and 03, the automated cattle crush (1) has a structure made up of vertical tubes (2) connected to horizontal tubes (3) and transverse tubes (4) where the horizontal tubes form the side of the cattle crush (1) while the vertical tubes (2) and transverse tubes (4) form the entrance door (5), the intermediate drag door assembly (6) and the exit drag door assembly (7) where bases (18) are provided for support and fixing to the ground or floor.

On the right or left side of the cattle crush (1), in the section between the entrance door (5) and the intermediate drag door assembly (6), a rectangular frame (8A) is provided for fitting one of the traction systems, the worm drive system (23) or the chain drive system (24).

On the right or left side of the cattle crush (1), in the section between the intermediate drag door assembly (6) and the exit drag door assembly (7), a rectangular frame (8B) is provided for fitting one of the traction systems, worm drive system (23) or chain drive system (24).

As shown in FIGS. 04 and 05, the intermediate drag door assembly (6) consists of two doors with two vertical tubes (2) with bases (18) and a transverse tube (4) connected by welding or a means of fitting. A rail (9) is fixed between these two portals, supported by brackets (14) on each side of the portals. Attached to the rail (9) by means of two supports with casters or pulleys (10) is a door made up of two vertical tubes (12) and horizontal tubes (13) and a handle (11). The door slides sideways along the track (9), opening and closing. This opening and closing movement can be manual or automatic by means of an electric motor with local or remote drive.

The exit drag door assembly (7) consists of a portal fitted with two vertical tubes (2) with bases (18) and a transverse tube (4) connected by welding or a means of fitting. A rail (9) is fixed to this portal, supported by brackets (14), one on each side of the portal. Attached to the rail (9) by means of two supports with casters or pulleys (10) is a door made up of two vertical tubes (12) and horizontal tubes (13) and a handle (11). The door slides sideways along the track (9), opening and closing. This opening and closing movement can be manual or automatic by means of an electric motor with local or remote drive.

FIG. 06 illustrates the top view of the cattle crush (1) showing the corridor formed by the vertical tubes (2), horizontal tubes (3) and transverse tubes (4) and the entrance door (5) and the sets of intermediate drag doors (6) and the exit drag door (7).

FIG. 07 illustrates an embodiment of a connection means between the vertical tubes (2) and horizontal tubes (3) made by a connection means, for example, a base (15) in the form of a welded half tube (16) on the vertical tube (2) where the horizontal tube (3) rests and is secured by a screw (17). In cases where the cattle crush (1) will be fixed in place, the horizontal tubes (3) can be welded to the vertical tubes (2).

FIGS. 08, 09 and 10 illustrate the cattle crush (1) fitted with a chain drive system (20) installed on the side of the cattle crush in the section between the entrance door (5) and the intermediate drag door assembly (6) and a worm drive system (19) on the side of the cattle crush (1) in the section between the intermediate drag door assembly (6) and the exit drag door assembly (7). As soon as the bovine's hind legs pass through the door (5), a cowhand inserts a bar (25) into a support for the chain bars (22) and, by activating the motor (23), the chain rotates clockwise, pushing the bovine forward. When the next bovine enters behind the first, the procedure is repeated by placing a new bar (25) behind the bovine's legs. The cattle are pushed by the bars (25) until they pass through the intermediate drag gate assembly (6).

When a bovine passes through the intermediate drag gate assembly (6), the gate is closed to prevent the bovine from backing up. At this point, a bar (25) is inserted into the support (32) behind the bovine's rear legs and the motor (27) is activated, causing the worm screw to rotate, moving the support (32) towards the exit drag door assembly (7). When the bovine is in the final position of the cattle crush (1), the exit drag door (7) is opened releasing the ox to exit the cattle crush (1).

At this point, the exit drag door (7) is closed and the intermediate drag door (6) is opened so that the next bovine is directed to the exit section of the cattle crush (1) and so on until all the bovine have passed through the cattle crush (1).

FIGS. 11 and 12 illustrate the intermediate drag door (6) and exit door (7) assemblies in which the doors slide laterally on the rails (9) by means of supports (10) fitted with castors or pulleys. You can see the position of the motors (23 and 27) of the chain drive (20) and worm drive (19) systems installed in the frames on the sides of the cattle crush (1) and the bars (25) used to push the cattle. These figures illustrate an embodiment where the doors are operated manually, but these can be automated using electric motors operated by local or remote control.

FIG. 13 illustrates the top view of the cattle crush (1) with the two traction systems by chain (20) and by worm gear (19) installed where the two traction systems extend along the entire side of the cattle crush where they are installed, allowing the cattle to be pushed with the bars (25) from the beginning of the cattle crush (1) to its exit.

FIGS. 14, 15 and 16 illustrate some of the constituent elements of the chain drive system. In this system, the chain (21) is equipped with links (28) and a bar support (22) is provided for every at least three links. The chain involves two toothed pulleys (24) one of which is connected to the motor (23) which drives the pulley (24) moving the chain (21) clockwise or anticlockwise allowing the bar (25) to move forwards or backwards in the cattle crush. On the side where the motor (23) is installed, the toothed pulley (24) is attached to a shaft connected to the motor (23) and this shaft is supported by two plates fixed to the support frame (33) of the chain drive system (20), one inner plate and one outer plate, through which the chain passes inside.

A base is attached to the outer plate where the motor (23) is supported. The support frame (33) has a rectangular shape and is made up of 4 channels. Inside this frame there is a channel (34) which, together with the upper channel of the frame (33), guides the upper part of the chain (21) and the supports (22) of the bars (25), and a rail (35) guides the lower part of the chain (21) and aligns the supports (22) of the bars (25), ensuring that the bars move forwards and backwards while remaining in a horizontal position and perpendicular to the chain (21). The motor (23) can be driven locally by a control or remotely using a microprocessor board with wireless communication to drive the control or mobile devices such as a cell phone, tablet, etc.

At the end opposite the motor (23) of the chain drive system (20), the toothed pulley (24) is attached to a shaft and this shaft is supported in an oblong hole in two plates fixed to the support frame (33) of the chain drive system (20), one inner plate and one outer plate, through which the chain passes inside. The oblong hole allows the chain to be tightened or loosened (21).

FIG. 17 shows the endless screw traction system (19) where an endless screw is confined in a column with a “U” profile and this screw is supported by two plates at the ends of the column and at one end the motor (27) is fixed which drives the screw which, by turning clockwise or anticlockwise, moves the support (32) of the bar forwards and backwards. The bracket has an internal thread compatible with the screw. The motor (27) can be driven locally by a control or remotely using a microprocessor board with wireless communication to drive the control or mobile devices such as a cell phone, tablet, etc.

Method of driving cattle in an automated cattle crush (1) characterized by the following steps:
(a) Close the intermediate drag doors (6) and the exit doors (7) of the cattle crush (1);
(b) Drive the motor (27) counterclockwise until the worm bar support (32) returns to its initial position next to the intermediate drag door (6);
(c) Lead a first bovine to the entrance of the cattle crush (5) until its hind legs pass through the entrance door;
(d) Insert a bar (25) into the bar holder (22) of the chain (21) just behind the bovine's hind legs;
(e) Drive the motor (23) clockwise, pushing the bovine forward with the bar (25);
(f) Switch off the engine (23) when there is enough space at the entrance to the cattle crush (5) for another bovine to enter;
(g) Lead a second bovine to the entrance of the cattle crush (5) until its hind legs pass through the entrance door;
(h) Insert a second bar (25) into the bar holder (22) of the chain (21) just behind the hind legs of the second bovine;
(i) Drive the motor (23) clockwise, pushing the cattle forward with the bar (25);
(j) Switch off the engine (23) when there is enough space at the entrance to the cattle crush (5) for another bovine to enter;
(k) Repeat the above steps until the section between the entrance door (5) and the intermediate drag door (6) of the cattle crush (1) is full of cattle;
(l) Open the intermediate drag door (6) and drive the motor (23) until the bovine enters the final section of the cattle crush between the intermediate drag door (6) and the exit drag door (7) and simultaneously drive a new bovine into the entrance (5) of the cattle crush (1) until its hind legs pass through the entrance door (5);
(m) Insert the bar (25) into the bar holder of the traction system (22) by means of a worm screw just behind the rear legs of the second bovine;
(n) Operate the motor (27) clockwise and push the bovine with the bar (25) forward until it is next to the exit drag door (7);
(o) Open the exit drag door (7);
(p) Operate the motor (27) clockwise and push the bovine with the bar (25) forward until it leaves the cattle crush (1); and
(q) Restart the above steps until all the cattle have been led out of the cattle crush (1).

If the cattle crush is configured with two worm drive systems (19), the method of driving cattle in an automated cattle crush (1) is characterized by the following steps:
(a) Close the intermediate drag doors (6) and the exit doors (7) of the cattle crush (1);
(b) Operate the two motors (27) in an anti-clockwise direction until the supports of the worm screw bar (32) return to the initial position next to the intermediate drag door (6) and next to the inlet door (5) of the cattle crush (1);
(c) Lead a first bovine to the entrance of the cattle crush (5) until its hind legs pass through the entrance door;
(d) Insert a bar (25) into the bar holder (32) of the first worm drive system (19) just behind the bovine's hind legs;
(e) Drive the motor (27) of the first worm drive system (19) clockwise, pushing the bovine with the bar (25) forward;
(f) Switch off the motor (27) of the first worm drive system (19) when the cattle are close to the intermediate drag gate (6);
(g) Open the intermediate drag gate (6) and drive the motor (27) of the first worm drive system (19) until the bovine enters the final section of the cattle crush (1) between the intermediate drag gate (6) and the exit drag gate (7);
(h) Close the intermediate drag door (6);
(i) Operate the motor (27) of the first worm drive system (19) in an anti-clockwise direction until the worm drive bar support (32) returns to its initial position next to the entrance door (5) of the cattle crush (1);
(j) Insert the bar (25) into the bar holder of the second worm drive system (22) just behind the rear legs of the bovine which is between the intermediate drag door (6) and the exit drag door (7);
(k) Operate the motor (27) of the second worm drive system (22) clockwise and push the cattle with the bar (25) forward until it is next to the exit drag door (7);
(l) Open the exit drag door (7);
(m) Operate the motor (27) of the second worm drive system (22) clockwise and push the cattle with the bar (25) forward until it leaves the cattle crush (1), and;
(n) Restart the above steps until all the cattle have been led out of the cattle crush (1).

1. A cattle crush automation system having a structure made up of vertical tubes connected to horizontal tubes forming the side of the cattle crush and transverse tubes where the vertical tubes and transverse tubes form the entrance door
an intermediate drag door assembly,
an exit drag door assembly
where bases are provided which are fixed to the ground or floor, on the right or left side of the cattle crush,
where, in the section between the entrance door and the intermediate drag door assembly, a rectangular frame is provided for fitting one of the drive systems, either the worm drive system or the chain drive system,
where, on the right or left side of the cattle crush in the section between the intermediate drag door assembly and the exit drag door assembly, a rectangular frame is provided for fitting one of the traction systems, worm drive system or chain drive system.

2. The system according to claim 1, wherein the intermediate drag door assembly is formed by
two portals equipped with two vertical tubes with bases and a transverse tube connected by welding or a means of fitting, between these two portals is fixed a rail supported on brackets one on each side of the portals,
where, coupled to the rail, by means of two supports with castors or pulleys a door is provided consisting of two vertical tubes and horizontal tubes and a handle,
where the door slides sideways along the track opening and closing, and
where this opening and closing movement is manual or automatic by means of an electric motor with local or remote activation.

3. The system according to claim 1, wherein the exit drag door assembly being formed by
a portal fitted with two vertical tubes with bases and a transverse tube connected by welding or a means of fitting,
where, in this portal, a rail is fixed, supported by brackets one on each side of the portal,
where, coupled to the rail by means of two supports with castors or pulleys, a door is provided consisting of two vertical tubes and horizontal tubes and a handle,
where the door slides sideways along the track opening and closing,
where this opening and closing movement is manual or automatic by means of an electric motor with local or remote activation.

4. The system according to claim 1, wherein the vertical tubes, horizontal tubes and transverse tubes, the entrance door, the intermediate drag door assemblies, and the exit drag door form a corridor.

5. The system according to claim 1, wherein the means of connection between the vertical tubes and horizontal tubes being carried out by means of a base in the form of a half tube welded to the vertical tube on which the horizontal tube rests and which is secured by a screw.

6. The system according to claim 1, wherein the means of attachment between the horizontal and the vertical being carried out by means of welding.

7. The system according to claim 1, wherein the chain drive system (20) being installed on the side of the cattle crush in the section between the entrance door (5) and the intermediate drag door assembly (6).

8. The system according to claim 1, wherein the chain drive system (20) is installed in the section between the intermediate drag door assembly (6) and the exit drag door assembly (7).

9. The system according to claim 1, wherein the worm drive system (19) being installed on the side of the cattle crush in the section between the entrance door (5) and the intermediate drag door assembly (6).

10. The system according to claim 1, wherein the worm drive system is installed in the section between the intermediate drag door assembly and the exit drag door assembly.

11. The system according to claim 1, wherein the chain drive system being provided with a chain consisting of links and every at least three links a bar support is provided,
where the chain involves two toothed pulleys, one of which is connected to the motor which drives the pulley, moving the chain clockwise or anti-clockwise, moving the bar forward or backward in the cattle crush,
where, on the side where the motor is installed, the toothed pulley is attached to a shaft connected to the motor and this shaft is supported by two plates fixed to the support frame of the chain drive system (20), one inner plate and one outer plate, through which the chain passes inside,
where, on the outer plate, a base is fixed where the motor is supported,
where the support frame has a rectangular shape and is made up of 4 channels, and inside this frame there is a channel which, together with the upper channel of the frame, guides the upper part of the chain and the supports of the bars,
where a rail serves as a guide for the lower part of the chain aligning the supports of the bars ensuring that the bars move forwards and backwards while remaining in a horizontal position and perpendicular to the chain,
where the motor is driven locally by a control or is driven remotely with the use of a microprocessor board with wireless communication for driving with control or mobile devices,
where, at the end opposite the motor of the chain drive system, the toothed pulley is attached to a shaft and this shaft is supported in an oblong hole in two plates fixed to the support frame of the chain drive system, one inner plate and one outer plate, through which the chain passes inside and the oblong hole allows the chain to be tightened or loosened.

12. The system according to claim 1, wherein the endless screw traction system being equipped with an endless screw confined in a column with a “U” profile and this screw being supported by two plates at the ends of the column and at one end the motor is fixed which drives the screw that when rotating clockwise or counterclockwise moves the support of the bar back and forth,
where the bracket has an internal thread compatible with the screw,
where the motor is driven locally by a control or remotely using a microprocessor board with wireless communication for control or mobile device operation.

13. A method for driving cattle in an automated cattle crush, as defined in claim 1, wherein the following steps:
(a) Close the intermediate drag doors and the exit doors of the cattle crush;
(b) Drive the motor counterclockwise until the worm bar support returns to its initial position next to the intermediate drag door;
(c) Lead a first bovine to the entrance of the cattle crush until its hind legs pass through the entrance door;
(d) Insert a bar into the bar holder of the chain just behind the bovine's hind legs;
(e) Drive the motor clockwise, pushing the bovine forward with the bar;
(f) Switch off the engine when there is enough space at the entrance to the cattle crush for another bovine to enter;
(g) Lead a second bovine to the entrance of the cattle crush until its hind legs pass through the entrance door;
(h) Insert a second bar into the bar holder of the chain just behind the hind legs of the second bovine;
(i) Drive the motor clockwise, pushing the cattle forward with the bar;
(j) Switch off the engine when there is enough space at the entrance to the cattle crush for another bovine to enter;
(k) Repeat the above steps until the section between the entrance door and the intermediate drag door of the cattle crush is full of cattle;
(l) Open the intermediate drag door and drive the motor until the bovine enters the final section of the cattle crush between the intermediate drag door and the exit drag door and simultaneously drive a new bovine into the entrance of the cattle crush.
(1) until its hind legs pass the entrance door;
(m) Insert the bar into the bar holder of the traction system by means of a worm screw just behind the rear legs of the second bovine;
(n) Operate the motor clockwise and push the bovine with the bar forward until it is next to the exit drag door;
(o) Open the exit drag door;
(p) Operate the motor clockwise and push the bovine with the bar forward until it leaves the cattle crush; and
(q) Restart the above steps until all the cattle have been led out of the cattle crush.

14. The method for driving cattle in an automated cattle crush, as defined in claim 1, wherein the following steps:
(a) Close the intermediate drag doors and the exit doors of the cattle crush;
(b) Operate the two motors anti-clockwise until the auger bar brackets return to the starting position next to the intermediate drag door and next to the entrance door of the cattle crush;
(c) Lead a first bovine to the entrance of the cattle crush until its hind legs pass through the entrance door;
(d) Insert a bar into the bar holder of the first worm drive system just behind the bovine's hind legs;
(e) Drive the motor of the first worm drive system clockwise, pushing the bovine with the bar forward;
(f) Switch off the motor of the first worm drive system when the cattle are close to the intermediate drag gate;
(g) Open the intermediate drag gate and drive the motor of the first worm drive system until the bovine enters the final section of the cattle crush between the intermediate drag gate and the exit drag gate;
(h) Close the intermediate drag door;
(i) Drive the motor of the first worm drive system counterclockwise until the worm drive bar support returns to its initial position next to the entrance door of the cattle crush;
(j) Insert the bar into the bar holder of the second worm drive system just behind the rear legs of the bovine which is between the intermediate drag door and the exit drag door;
(k) Operate the motor of the second worm drive system clockwise and push the cattle with the bar forward until it is next to the exit drag gate;
(l) Open the exit drag door;
(m) Operate the motor of the second worm drive system clockwise and push the cattle with the bar forward until it leaves the cattle crush, and;
(n) Restart the above steps until all the cattle have been led out of the cattle crush.
